(19) United States
(12) Patent Application Publication
(10) Pub. No.: US 2007/0263955 A1
(43) Pub. Date: Nov. 15, 2007

(54) METHOD AND APPARATUS FOR IMPROVING ACCURACY OF OPTIC SENSORS USED IN CAPILLARY TUBE INSTRUMENTS

(76) Inventors: Jeffrey KEEN, Edmonton (CA); David Wellar, Edmonton (CA)

Correspondence Address: DAVIS & BUJOLD, P.L.L.C., 112 PLEASANT STREET, CONCORD, NH, 03301, US

(21) Appl. No.: 11/747,668

(22) Filed: May 11, 2007

(30) Foreign Application Priority Data
May 11, 2006 (CA) 2548931

(51) Int. Cl. G02B 6/00

(52) U.S. Cl. 385/12

(57) ABSTRACT

A method for improving accuracy of optic sensors used in capillary tube instruments. The method involving the step of positioning an optic beam shaping body between the optic sensor and the capillary tube. The optic beam shaping body is adapted to impart corrective shaping upon the optic beam to counteract refraction resulting from differing densities of fluids.

### FIELD OF THE INVENTION

The present invention relates to a method and apparatus for improving accuracy of optic sensors used in capillary tube instruments.

### BACKGROUND OF THE INVENTION

U.S. Pat. No. 5,756,883 (The Fluid Life Corporation 1998) entitled “Method of continuously testing the accuracy of results obtained from an automatic viscometer”, is an example of a capillary tube instrument that uses optic sensors. The accuracy of The Fluid Life Corporation instrument is dependent upon a rapid response from the optic sensors used.

However, sensor accuracy is adversely effected by the fact that light tends to refract as it goes from a fluid of a first density to a fluid of a second density.

### SUMMARY OF THE INVENTION

According to one aspect of the present invention there is provided a method for improving accuracy of optic sensors used in capillary tube instruments. The method involving the step of positioning an optic beam shaping body between the optic sensor and the capillary tube. The optic beam shaping body is adapted to impart corrective shaping upon the optic beam to counteract refraction resulting from differing densities of fluids.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view of an optic sensor with a first embodiment of an optic beam shaping body constructed in accordance with the teachings of the present invention.

FIG. 2 is a side elevation view of an optic sensor with a second embodiment of an optic beam shaping body constructed in accordance with the teachings of the present invention.

FIG. 3 is a top plan view of an optic sensor configuration.

FIG. 4 (labelled as PRIOR ART) is a side elevation view of an optic sensor showing optic beam refraction in air.

FIG. 5 (labelled as PRIOR ART) is a side elevation view of an optic sensor showing optic beam refraction in oil.

### DETAILED DESCRIPTION OF THE PREFERRED EMBODIMENT

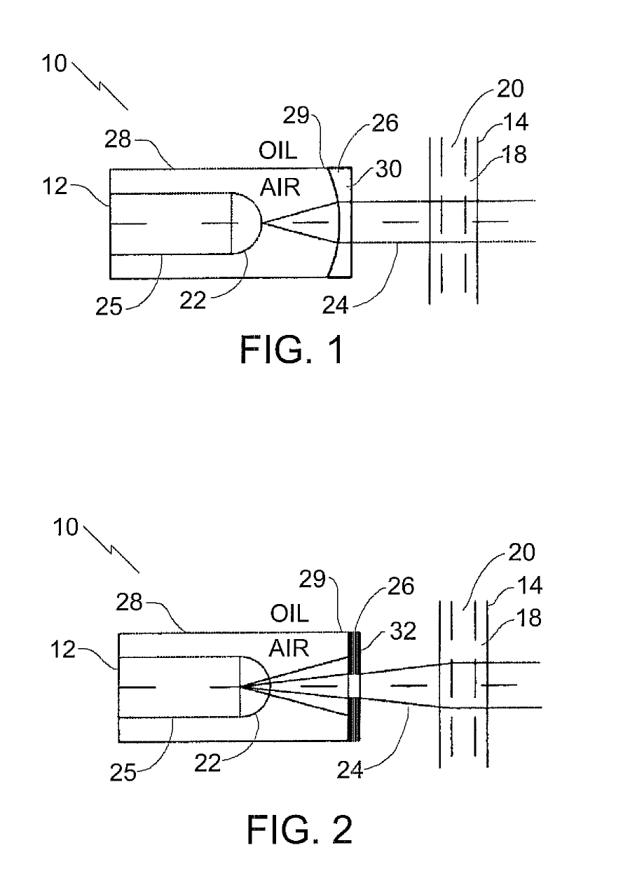

The preferred method will now be described with reference to FIG. 1 through FIG. 5.

### DESCRIPTION OF PRIOR ART

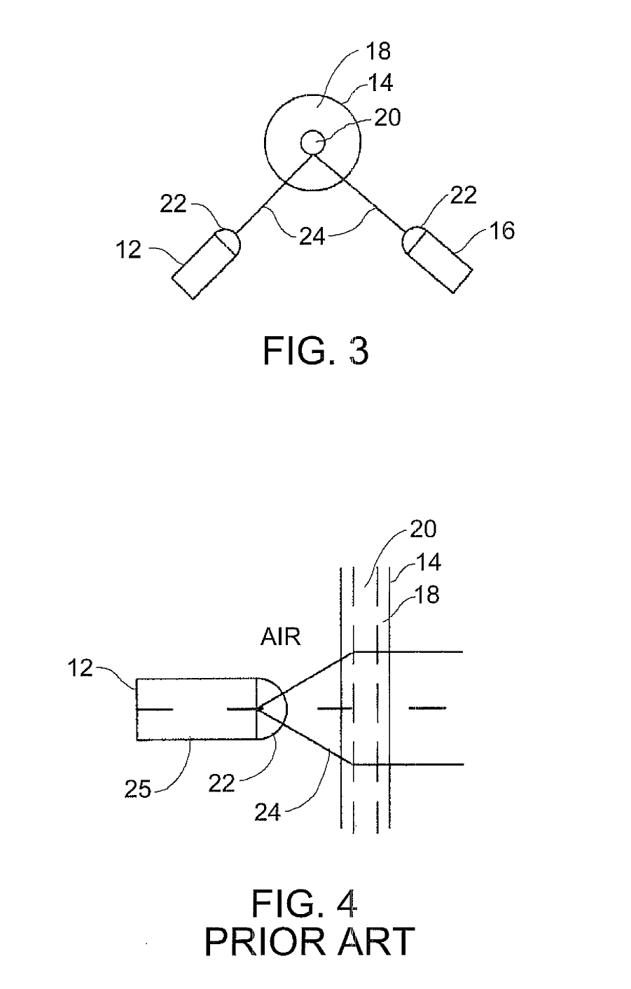

Referring to FIG. 3, in the optical meniscus sensing system described here, light is sent from a transmitter 12 and bounced off a capillary tube 14 to a receiver 16 normally located at a 90-degree rotation in the cylindrical axis. The reflection occurs on the transition from the capillary tube glass 18 to the hollow tube 20 in the middle of capillary tube 14. When the refractive index of the material in hollow tube 20 is significantly below that of glass 18, a total internal reflection occurs, allowing most of the transmitted light to impinge on receiver 16. This situation happens when hollow tube 20 is filled with air, for example. When the refractive index of the material in tube 20 changes to be closer to that of glass is, less light is reflected back to receiver 16, allowing one to determine when the material in hollow tube 20 changes. This effect is used to detect the change from one material to another. When applied to liquids, where the transition forms a meniscus, this allows one to detect the position of the meniscus relative to the optical system.

In normal practice, it is sometimes desirable to hold the liquid material in capillary tube 14 at a constant temperature while detecting the position of the meniscus while the liquid flows. One way to achieve this is to immerse the entire assembly in a bath of liquid, which is then held at a constant temperature by a heater/cooler and control system (not shown). Unfortunately, this liquid bath can interact with the optical detection system in a negative way.

In a practical optical system, receiver 12 and transmitter 16 have lenses 22, which serve to focus the light beam into a defined shape. Referring to FIG. 4, most of these lenses are designed to operate in air, and ones suitable for the detection system will provide a beam 24 with a small beam spread and use a highly curved lens 22 to achieve this small beam. As can be readily appreciated, due to the fact that the optical system must be a short distance from hollow tube 20 in capillary 14 (due to the glass if nothing else), the smaller the beam spread, the less distance in the axial direction of capillary tube 14 will be seen or illuminated by beam 24. This is preferable because the less distance seen by the optical system, the more accurately we can determine the position of the liquid meniscus in capillary tube 14 relative to the optical detection system.

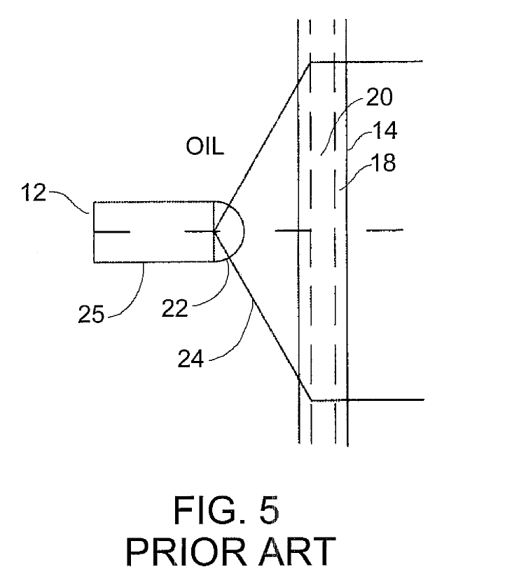

Referring to FIG. 5, the presence of the liquid bath, such as oil, that the optical system is immersed in changes the action of the lenses 22 in the optical system. Typically, the refractive index of the bath liquid acts to increase beam spread, and has been found to more than double the spread. This acts to increase the distance of capillary tube 14 seen by the system and degrades its positional accuracy. The present invention allows one to improve the positional accuracy of the readings of the optical sensor in the face of this problem.

### First Embodiment

Referring to FIG. 1, there is shown an apparatus 10 for improving the accuracy of optic sensors used in capillary tube instruments, and specifically, the positional accuracy of optical liquid meniscus detection in a capillary tube. Apparatus 10 includes an optic sensor (transmitter 12 as depicted, but it may also be receiver 16) having an associated optic beam shaping body 26 adapted to impart corrective shaping upon the optic beam 24 to counteract refraction resulting from differing densities of fluids. The individual optical components, such as the light source 25 and The lens 22 of the detection system, are housed in a housing 28 that contains a material with a lower index of refraction than that of the material in the heat bath, such as air. The beam shaping body 26 is located at the transmission end of housing 28. In this first embodiment, optic beam shaping body 26 is a focusing lens 30 adapted to focus optic beam 24 in order to reduce the negative effects of dispersion.

Focusing lens (or corrective lens) 30 is placed between light source 25 and lens 22 and capillary tube 14 allowing one to control the beam spread of beam 24. It also creates the opportunity to add an optical mask to further refine the beam shape, as discussed below in the second embodiment. While the same effect could be achieved by strengthening lens 22, it is not practical to strengthen lens 22 by increasing its curvature or increase its index of refraction by changing materials due to the cost of such changes to mass produced components and the already highly curved design of lens 22.

Lens 30 can take different forms. For example, it could comprise a straight lens. This restores the beam spread to the original optical component design if the chamber is filled with air. With a smaller beam spread, less of the capillary tube axial distance is illuminated and/or seen and this reduced visible area increases the positional accuracy of the detection of the meniscus position. Other options include concave, convex, or compound lenses to give more control over the spread and shape of beam 24 and thus better meniscus position detection. FIG. 1 shows the use of a concave lens.

### Second Embodiment

Referring now to FIG. 2, there is shown an alternative embodiment similar to that described above. However, in this embodiment, optic beam shaping body 26 is a mask 32 adapted to block selected portions of optic beam 24. Optical mask 32 is positioned next to or on lens 22. As depicted, optical mask 32 is located on transmission end 29 of housing 28. The shape of mask 32 can be a simple line, or any other shape that accurately controls the resulting shape of beam 24 and thus the part of capillary tube 14 illuminated and/or seen further increasing the positional accuracy. Finally, a combination of focusing lens 30 as a concave, convex, or compound lens with optical mask 32 to gain the most amount of control over beam 26 and thus the positional accuracy of the meniscus detection.

Operation

Referring to FIGS. 1 through 3, apparatus 10 is provided as described above. Referring to FIG. 3, light source 25 emits optic beam 24 which passes through lens 22 to be shaped, and enters capillary tube 14. If hollow tube 20 is empty, beam 24 is reflected off the interface between glass 18 and hollow tube 20, and is received by receiver 16. If hollow tube 20 is filled with a material with a higher index of refraction than air, less light is reflected, and receiver 16, such that receiver 16 is able to detect a meniscus of fluid as it passes through capillary tube 14. When a narrower beam 24 is desired, such as when apparatus 10 is placed in a heat bath such that it is surrounded by a material of a higher index of refraction that causes beam 24 to spread more than before, optical beam shaping body 26 is introduced between the optic sensor and the capillary tube. Optic beam shaping body 26 is adapted to impart corrective shaping upon optic beam 24 to counteract refraction resulting from differing densities of fluids. Light source 25 and lens 22 are positioned in housing 28, and optic beam shaping body 26 is positioned at transmission end 29 of housing 28. Referring to FIG. 1, optic beam shaping body 26 may be focusing lens 30 adapted to focus optic beam 24, or optical mask 32 adapted to block selected portions of optic beam 24.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A method for improving accuracy of optic sensors used in capillary tube instruments, comprising the step of:
positioning an optic beam shaping body between the optic sensor and the capillary tube, the optic beam shaping body being adapted to impart corrective shaping upon the optic beam to counteract refraction resulting from differing densities of fluids.

2. The method as defined in claim 1, wherein the optic beam shaping body is a focusing lens adapted to focus the optic beam.

3. The method as defined in claim 1, wherein the optic beam shaping body is a mask adapted to block selected portions of the optic beam.

4. An apparatus for improving accuracy of optic sensors used in capillary tube instruments, comprising:
an optic sensor having an associated optic beam shaping body adapted to impart corrective shaping upon the optic beam to counteract refraction.

5. The apparatus as defined in claim 4, wherein the optic beam shaping body is a focusing lens adapted to focus the optic beam.

6. The apparatus as defined in claim 4, wherein the optic beam shaping body is a mask adapted to block selected portions of the optic beam.
